(19) United States
(12) Patent Application Publication
(10) Pub. No.: US 2016/0253884 A1
(43) Pub. Date: Sep. 1, 2016

(54) HOME AUTOMATION SYSTEMS, METHODS, AND COMPUTER-READABLE MEDIA

(71) Applicant: CastleOS Software, LLC, Johnston, RI (US)

(72) Inventor: Christopher Cicchitelli, Boston, MA (US)

(21) Appl. No.: 14/868,302

(22) Filed: Sep. 28, 2015

Related U.S. Application Data
(63) Continuation of application No. PCT/US2015/021351, filed on Mar. 18, 2015.
(60) Provisional application No. 61/954,782, filed on Mar. 18, 2014.

(51) Int. Cl. G08B 13/22; H04L 12/28; H04W 4/20; H04L 29/08

(52) U.S. Cl. CPC G08B 13/22; H04L 67/26; H04L 12/2823; H04L 12/2816; H04W 4/20

(57) ABSTRACT

One aspect of the invention provides a method of monitoring status of a hardware device. The method includes: obtaining status information for one or more hardware devices; and communicating with a push notification service to generate a push notification containing the status information for the one or more hardware devices.

### CROSS-REFERECE TO RELATED APPLICATION

This application is a continuation under 35 U.S.C. §120 of International Application No. PCT/US2015/021351, filed Mar. 18, 2015, which claims priority to U.S. Provisional Application Ser. No. 61/954,782, filed Mar. 18, 2014. The entire content of each application is hereby incorporated by reference herein.

### BACKGROUND

Although home automation technology has existed in various forms for decades, such technology has not achieved widespread consumer adoption.

### SUMMARY OF THE INVENTION

One aspect of the invention provides a method of monitoring status of a hardware device. The method includes: obtaining status information for one or more hardware devices; and communicating with a push notification service to generate a push notification containing the status information for the one or more hardware devices.

This aspect of the invention can have a variety of embodiments. The hardware device can be selected from the group consisting of: an electronic switch, a garage door, a thermostat, audio-visual equipment, security systems, a domestic robot, a coffeemaker, an irrigation system, a sump pump, and swimming pool equipment.

The hardware device can support one or more standards selected from the group consisting of: INSTEON®, UPB®, X10®, Z-WAVE®, and ZIGBEE®.

The method can further include: receiving the push notification on a computing device; and updating a widget depicted on a homepage of the computing device to reflect the status information. The computing device can be selected from the group consisting of: a smartphone, a tablet, and a general purpose computer. The method can further include: detecting a user manipulation of the widget; and in response to the user manipulation of the widget, generating and transmitting one or more instructions for control of the one or more hardware devices.

Another aspect of the invention provides a method of monitoring status of a hardware device. The method includes: obtaining status information for one or more hardware devices; and communicating with a push notification service to generate a push notification containing the status information for the one or more hardware devices.

Another aspect of the invention provides a non-transitory computer readable medium containing program instructions executable by a processor. The computer readable medium includes: program instructions that obtain status information for one or more hardware devices; and program instructions that communicate with a push notification service to generate a push notification containing the status information for the one or more hardware devices.

Another aspect of the invention provides a controller adapted and configured to perform the methods described herein.

Another aspect of the invention provides a method of detecting a potential emergency within a structure. The method includes: detecting a pre-defined pattern of actuations of a hardware device; and upon detecting the pre-defined pattern of actuations of the hardware device, reporting a potential emergency to an emergency dispatch center.

This aspect of the invention can have a variety of embodiments. The hardware device can be an electronic switch. The hardware device can supports one or more standards selected from the group consisting of: INSTEON®, UPB®, X10®, Z-WAVE®, and ZIGBEE®. The pre-defined pattern can be user-defined. The pattern can be a sequence of three “ON” actuations, followed by three “OFF” actuations, followed by three “ON” actuations. The pattern can be a sequence of gestures. The sequence of gestures can be gesturing a “9”, followed by gesturing a “1”, followed by gesturing a “1”. The sequence of gestures can be gesturing an “H”, followed by gesturing an “E”, followed by gesturing an “L” , followed by gesturing a “P”.

The step of reporting the potential emergency to the emergency dispatch center can include one or more selected from the group consisting of: providing information regarding the user that signaled the potential emergency, providing information regarding the location of the potential emergency, providing one or more photograph of the location of the potential emergency, providing audio of the location of the potential emergency, providing video of the location of the potential emergency, and initiating a telephone call between the person that signaled the potential emergency and the emergency dispatch center.

Another aspect of the invention provides a non-transitory computer readable medium containing program instructions executable by a processor. The computer readable medium includes: program instructions that detect a pre-defined pattern of actuations of a hardware device; and program instructions that, upon detecting the pre-defined pattern of actuations of the hardware device, report a potential emergency to an emergency dispatch center.

Another aspect of the invention provides a controller adapted and configured to perform the methods described herein.

Another aspect of the invention provides a method of detecting a particular person within a room. The method includes: utilizing a skeletal detection algorithm to identify one or more humans; capturing one or more images including one or more faces of the one or more humans; and using a facial recognition algorithm to identify the one or more humans.

This aspect of the invention can have a variety of embodiments. The method can further include: detecting whether the one or more humans are authorize to be in the room; and if the one or more humans are not authorized to be in the room, generating an alarm.

Another aspect of the invention provides a non-transitory computer readable medium containing program instructions executable by a processor. The computer readable medium includes: program instructions that utilize a skeletal detection algorithm to identify one or more humans; program instructions that capture one or more images including one or more faces of the one or more humans; and program instructions that use a facial recognition algorithm to identify the one or more humans.

Another aspect of the invention provides a controller adapted and configured to perform the methods described herein.

Another aspect of the invention provides a method of detecting an anomalous event. The method includes: monitoring behavior of an individual using one or more sensors; logging the behavior; deriving a plurality of patterns from the behavior; monitoring additional behavior; and comparing the additional behavior to plurality of patterns derived from the behavior.

This aspect of the invention can have a variety of embodiments. The method can further include: if the additional behavior does not match one of the plurality of patterns, comparing the additional behavior to one or more pre-defined anolomalous patterns; and if one or more anomalous patterns are detected, contacting an emergency dispatch center.

Another aspect of the invention provides a controller adapted and configured to perform the methods described herein.

Another aspect of the invention provides a non-transitory computer readable medium containing program instructions executable by a processor. The computer readable medium includes: program instructions that monitor behavior of an individual using one or more sensors; program instructions that log the behavior; program instructions that derive a plurality of patterns from the behavior; program instructions that monitor additional behavior; and program instructions that compare the additional behavior to plurality of patterns derived from the behavior.

Another aspect of the invention provides a method of reporting an emergency. The method includes: detecting that a user announced an emergency; parsing the user's speech to identify additional information about the emergency; and reporting the emergency to an emergency dispatch center along with one or more selected from the group consisting of: additional speech by the user or other humans, a location of the user; information regarding recent door openings; information regarding motion sensor readings, information regarding occupants of one or more rooms, and a photograph of a room.

This aspect of the invention can have a variety of embodiments. The method can further include acknowledging receipt of the emergency by taking one or more actions selected from the group consisting of: playing one or more sounds and flashing lights within the room. The location of the user can specify a particular room within a structure.

Another aspect of the invention provides a controller adapted and configured to perform the methods described herein.

Another aspect of the invention provides a non-transitory computer readable medium containing program instructions executable by a processor. The computer readable medium can include: program instructions that detect that a user announced an emergency; program instructions that parse the user's speech to identify additional information about the emergency; and program instructions that report the emergency to an emergency dispatch center along with one or more selected from the group consisting of: additional speech by the user or other humans, a location of the user, information regarding recent door openings, information regarding motion sensor readings, information regarding occupants of one or more rooms, and a photograph of a room.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views and wherein:

FIG. 1 depicts an exemplary home automation system according to an embodiment of the invention;

FIGS. 2 and 3 depict exemplary methods of configuring a home automation system according to an embodiment of the invention;

FIG. 4 depicts a method of monitoring status of a hardware device such as a peripheral according to an embodiment of the invention;

FIG. 5 depicts a method of detecting a potential emergency within a structure according to an embodiment of the invention;

FIG. 6 depicts a method of detecting a particular person within a room according to an embodiment of the invention;

FIG. 7 depicts a method of detecting an anomalous event according to an embodiment of the invention;

FIG. 8 depicts a method of reporting an emergency according to an embodiment of the invention; and

FIGS. 9A-9S depicts exemplary screenshots for a smartphone app according to an embodiment of the invention.

### DETAILED DESCRIPTION OF THE INVENTION

Aspects of the invention relate to home automation systems. Typical components of a home automation system include: a central controller or gateway, one or more control interfaces, and one or more home automation devices.

The central controller or gateway acts as a bridge between the automation devices and the apps that allow control of those devices. Each network typically has only one, however, some networks can have one central controller, with several sub controllers (for instance, for a security sub-system). This can be software running on a typical computer, or a dedicated microcontroller.

The one or more control interfaces to the central controller/gateway can include mobile apps, web apps, PC/Mac apps, voice recognition apps such as that provided in CASTLEOS® software and CASTLEHUB™ hardware available from CastleOS Software, LLC of Johnston, Rhode Island, apps for in-wall touchscreens, and the like.

Home automation devices include: light switches; plug-in lamp or appliance modules; thermostats; sensors such as for leaks, motion, door/window opening, and the like; motor controllers for blinds, garages, pool pumps, and the like. This list is merely exemplary, as anything that uses electricity can be automated.

The central controller can be accessed over a home's internal network, from outside the home by allowing access through the home router, or in the case of cloud connected controllers, can be accessed and controlled from the cloud.

The home automation devices can communicate with each other via a communications protocols commercialized trademarks such as INSTEON®, Z-WAVE®, ZIGBEE®, UPB®, and the like. These protocols focus on command and control of devices. The central controller uses an adapter to talk to these devices and can translate between protocols. For instance, it can receive a message from a Z-WAVE® device, translate, and re-transmit it to an INSTEON® device.

Referring now to FIG. 1, an exemplary home automation system 100 is depicted. The home automation system 100 includes one or more controllers 102 adapted and configured to communicate with one or more sensors 104 and one or more peripherals 106.

Although the term “home automation” is used throughout the application for ease of reference, one of ordinary skill in the art will readily appreciate that the invention can be applied to a variety of structures including commercial and industrial settings.

The controller 102 can be a personal computer or a gaming console (e.g., the NINTENDO® WII® console available from Nintendo of America Inc. of Redmond, Wash.; the SONY® PLAYSTATION® console available from Kabushiki Kaisha Sony Corporation of Tokyo, Japan; the MICROSOFT® XBOX® console available from Microsoft Corporation of Redmond, Wash.; and the like). In some embodiments, one or more controllers 102 are located in one or more rooms within a structure.

The one or more sensors 104 can include various optical and/or video sensors such as cameras, range camera sensors, depth sensors, microphones, multi-array microphones and the like capable of 3D motion capture, facial recognition, voice recognition, acoustic source localization, and the like. Suitable sensors are available under the KINECT™ trademark from Microsoft Corporation of Redmond, Wash,, the AEOTEC® trademark from Aeon Labs LLC of El Cerrito, Calif., the NEST® PROTECT™ trademark from Google Inc. of Mountain View, Calif., the INSTEON® trademark from Smartlabs, Inc. of Irvine, Calif., the WEMO® trademark from Belkin International, Inc of Playa Vista, Calif., and the ECOLINK™ trademark from Ecolink Intelligent Technology, Inc. of Carlsbad, Calif.. In some embodiments, one or more sensors 104 are located in one or more rooms within a structure.

The one or more peripherals 106 can include devices that interact with the controller 102 such as an electrical switch, an electrical outlet, lighting, a lock, a garage door, a thermostat, audio-visual equipment, shade controllers, security systems, a domestic robot (e.g., a floor cleaning robot), a coffee maker, an irrigation system, a sump pump, swimming pool equipment, pet feeders, and the like. Various peripherals that communicate using the INSTEON®, Z-WAVE®, UPB, and/or X10® protocols are commercially available.

Exemplary electrical switches that can communicate with the controller 102 include INSTEON® dimmer switches available from Smartlabs, Inc. of Irvine, Calif., WEMO® brand switches available from Belkin International, Inc of Playa Vista, Calif., and LEVITON™ brand switches available from Leviton Manufacturing Co., Inc of Melville, N.Y. Exemplary electrical outlets that can communicate with the controller 102 are available under the LEVITON™ trademark Leviton Manufacturing Co., Inc of Melville, N.Y. Exemplary lighting that can communicate with the controller 102 are available under the INSTEON® trademark from Smartlabs, Inc. of Irvine, Calif. and under the PHILIPS™ trademark from Koninklijke Philips N.V. of Eindhoven, Netherlands. Exemplary locks that can communicate with the controller 102 are available under the YALE® trademark from Yale Security Inc. of Monroe, N.C., under the SCHLAGE® trademark from Schlage Lock Company LLC of Carmel, Indiana, and under the KWIKSET® trademark from Kwikset Corporation of Lake Forest, Calif. Exemplary thermostats that can communicate with the controller 102 are available under the NEST® trademark from Google Inc. of Mountain View, Calif., under the ECOBEE® trademark from Ecobee, Inc. of Ontario, Canada, under the HONEYWELL® trademark from Honeywell International Inc. of Morristown, N.J., under the TRANE® trademark from Trane International Inc. of Piscataway, N.J. Exemplary audio-visual equipment that can communicate with the controller 102 include the SONOS® PLAY:1®, SONOS® PLAY:3®, SONOS® PLAY:5®, SONOS® PLAYBAR®, SONOS® CONNECT™ wireless speakers available from Sonos, Inc. of Santa Barbara, Calif. Exemplary shade controllers that can communicate with the controller 102 are available under the SOMFY® trademark from Somfy SAS of Cluses, France.

A user can access sensor 104 and/or peripheral 106 from a remote device such as a general purpose computer 108, a table computer 110, a smartphone 112, and the like either directly via the Internet or indirectly through a webpage that serves an interface to the controller 102. Through this interaction, the user can monitor the status of and control one or more peripherals 106.

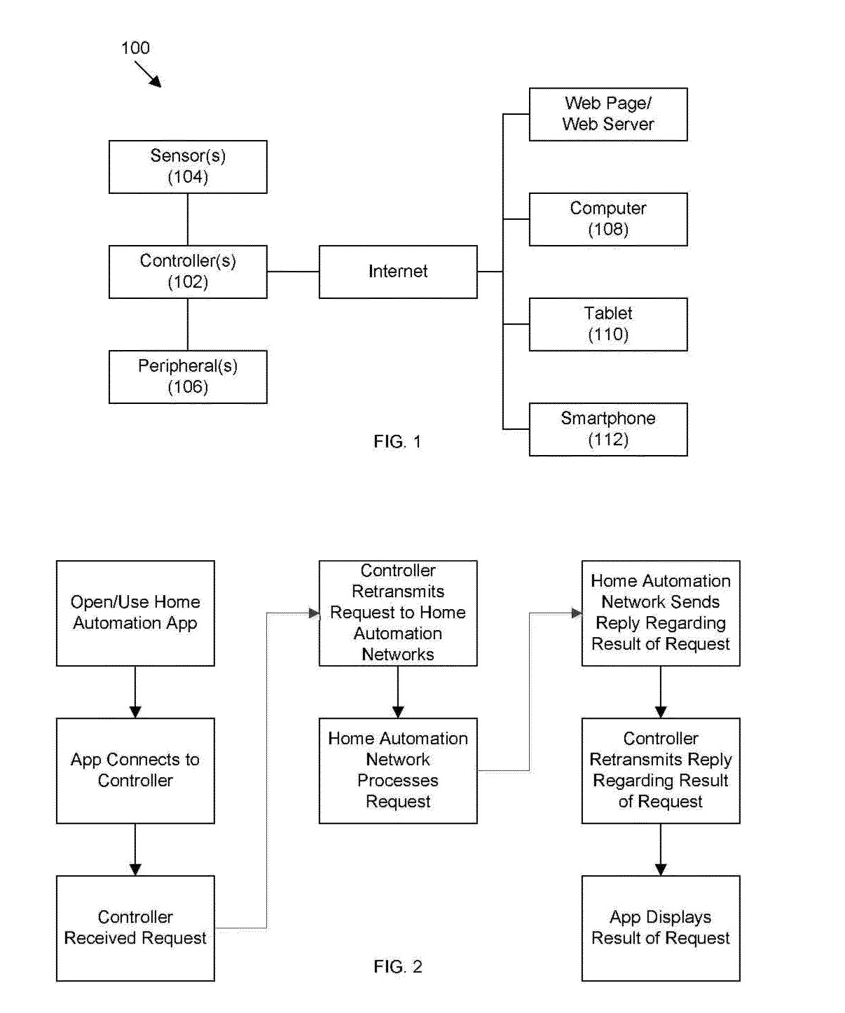

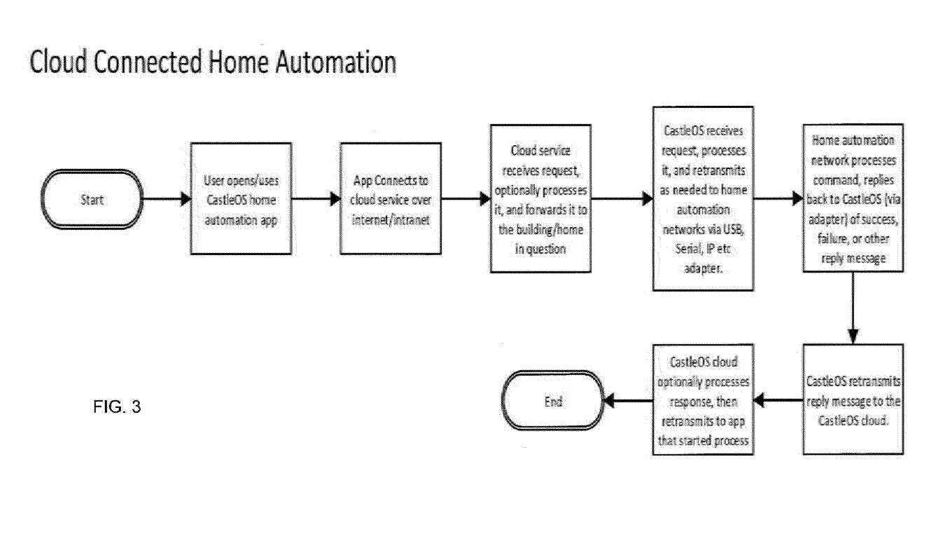

Exemplary methods of configuring a home automation system are depicted in FIGS. 2 and 3.

### Voice Control of Peripherals

Embodiments of the invention support voice control over one or more peripherals. For example, the controller 102 can be programmed to receive and parse a text stream from a voice recognition module (available, for example, from Nuance Communications, Inc. of Burlington, Mass.). For example, a user can say, “computer, turn on the living room chandelier,” “computer, turn on the master bathroom lights,” or “house, turn up the air conditioning.” The user can also designate a “master” light for one or more rooms and simply say “computer lights” to toggle the lights in their current room on and off.

The controller 102 can also be programmed by the user or by an installer to execute one or more scripts in response to voice commands. Scripts can be written in a variety of programming languages such as C#.

### Control of Devices by Home Screen Widget

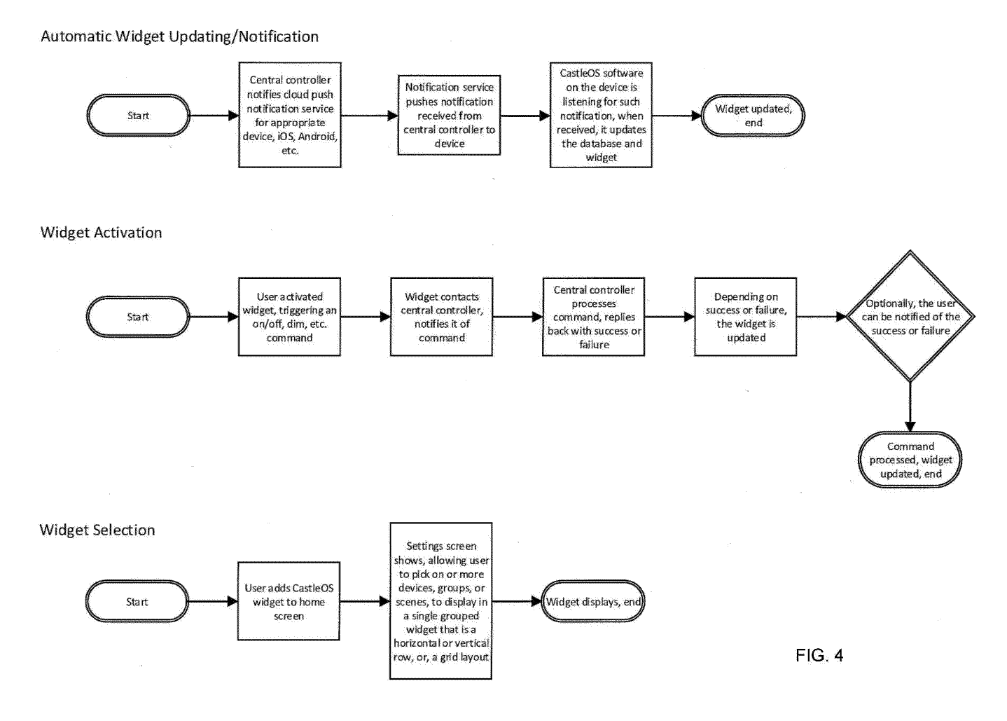

Referring now to FIG. 4, one aspect of the invention provides a method of monitoring status of a hardware device such as a peripheral 106. The method includes obtaining status information for one or more hardware devices and communicating with a push notification service to generate a push notification containing the status information for the one or more hardware devices.

In one embodiment, the controller 102 periodically communicates with a peripheral to determine its status. For example, if the peripheral 106 is an electrical switch, the peripheral 106 can report that it is “ON”, “OFF”, or in a dimmed state. This state can be forwarded from controller 102 to a user's general purpose computer 108, a table computer 110, a smartphone 112, and the like. Preferably, the communication is sent as a “push” notification so that the user's general purpose computer 108, table computer 110, or smartphone 112 receives the status update without the need for the user and/or the device to periodically poll the controller 102 for status or changes to status.

Once the status update is received, the user can be informed of the status change in a variety of ways. In one embodiment, a widget depicted on a homepage of the user's computing device is updated to reflect the status of the peripheral 106. A widget is a graphical user interface device that can be displayed and interacted with directly from a homepage. Thus, the can advantageously see if the garage door is open from the homepage of their device and close the garage door directly by pressing the widget and without the need to open a new window.

This instruction to control a peripheral 106 can be sent from the user's device to the controller 102 via the Internet and then relayed to the peripheral 106 by the controller 102 using one or more of the protocols discussed herein.

In some embodiments, one or more peripherals 106 can be grouped together and controlled as one by the widget. For example, touching the widget can turn on a group of lights in the user's living room.

Signaling of Emergency from Light Switch

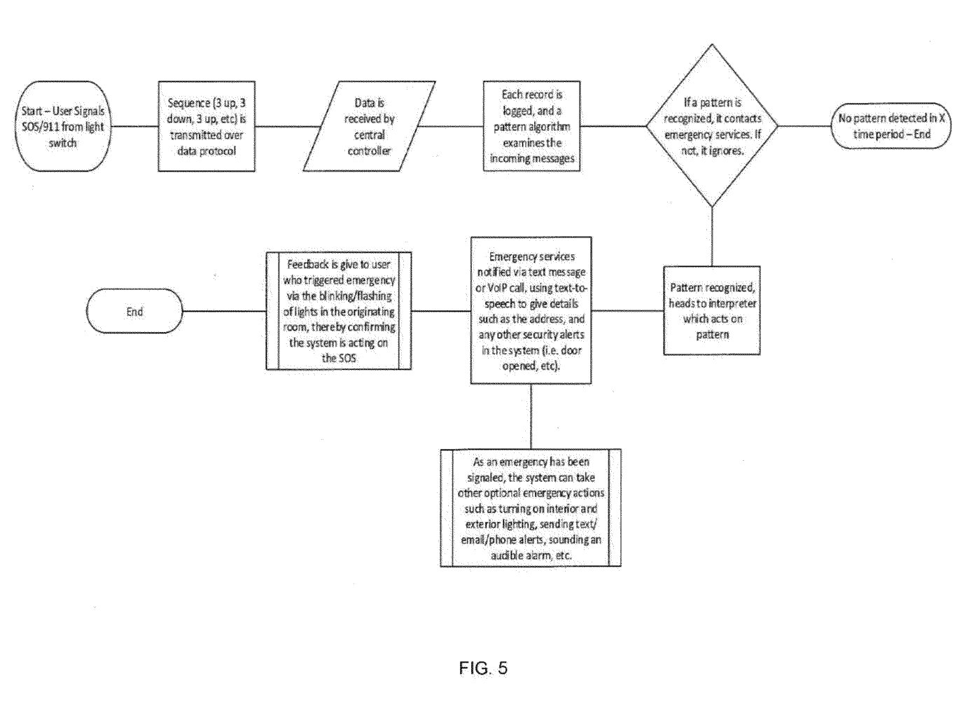

Referring now to FIG. 5, another aspect of the invention provides a method of detecting a potential emergency within a structure. The method includes: detecting a pre-defined pattern of actuations of a hardware device and, upon detecting the pre-defined pattern of actuations of the hardware device, reporting a potential emergency to an emergency dispatch center.

This method can allow a user to signal an emergency by utilizing a light switch in a room without the need for a user to have a telephone nearby. For example, the user can move the switch to the “ON” position three times, move the switch to the “OFF” position three times, and move the switch to the “ON” position three times. Each time the switch is moved to the “ON” or “OFF” position, the switch communicates its status to the controller 102. The controller 102 detects whether the pre-defined pattern occurred within a pre-defined time period and can report a potential emergency to an emergency dispatch center upon detection of the pre-defined pattern.

In another embodiment, the user can input a sequence of gestures using a peripheral 106 such as the UBE™ WI-FI Smart Dimmer available from Ube of Austin, Tex. For example, the user can draw a “9”, followed by a “1”, followed by a “1” or can draw an “H”, followed by an “E”, followed by an “L” , followed by a “P”.

### Intelligent Home Automation Based on Detection of Individual Humans

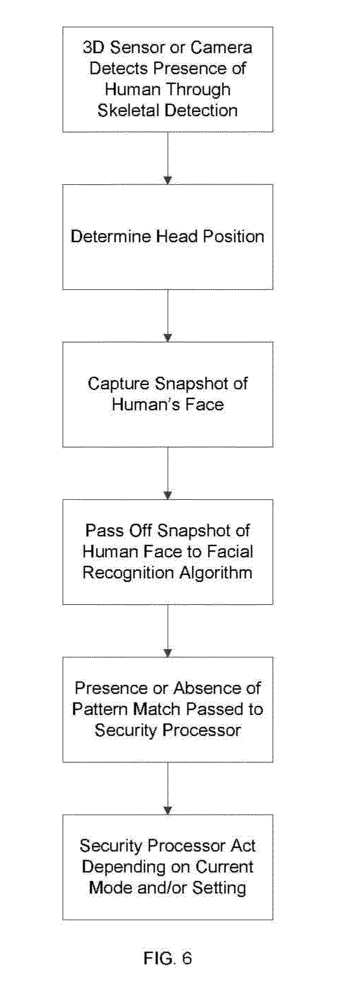

Referring now to FIG. 6, another aspect of the invention provides a method of detecting a particular person within a room. The method includes utilizing a skeletal detection algorithm to identify one or more humans; capturing one or more images including one or more faces of the one or more humans; and using a facial recognition algorithm to identify the one or more humans.

### Automated Detection of Illness, Injuries, and Other Anomalies

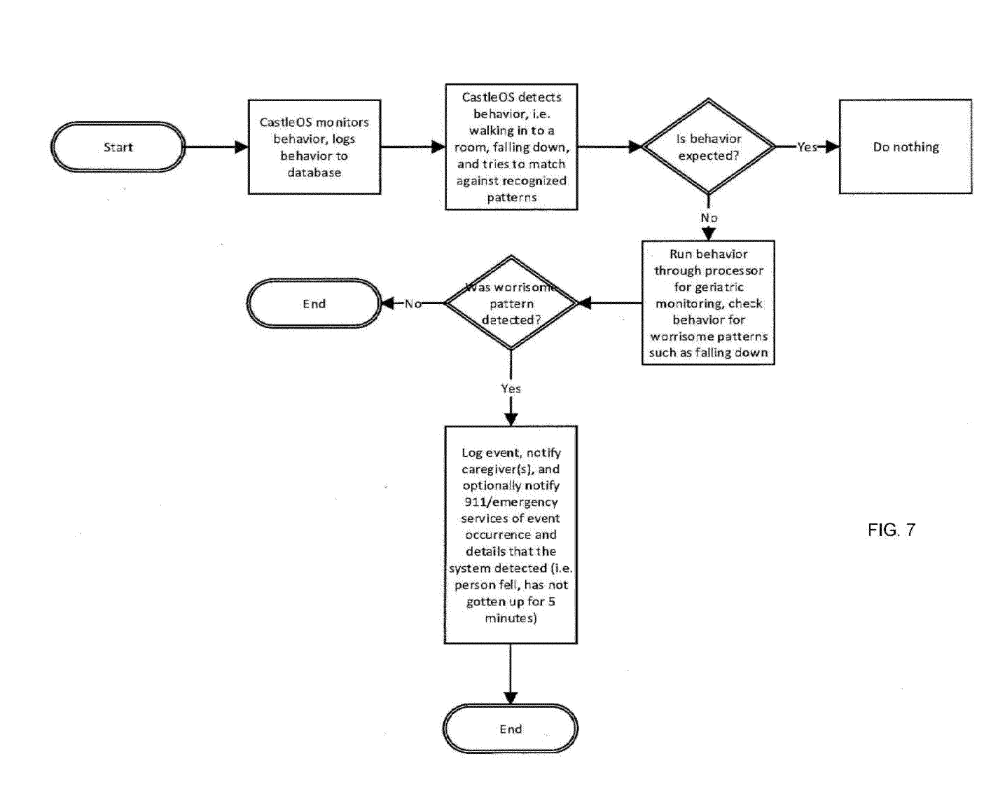

Referring now to FIG. 7, another aspect of the invention provides a method of detecting an anomalous event. The method includes monitoring behavior of an individual using one or more sensors; logging the behavior; deriving a plurality of patterns from the behavior; monitoring additional behavior; and comparing the additional behavior to plurality of patterns derived from the behavior.

### Automated Emergency Dialing Systems and Methods

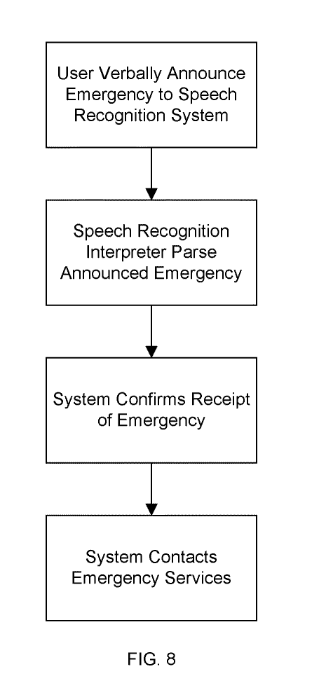

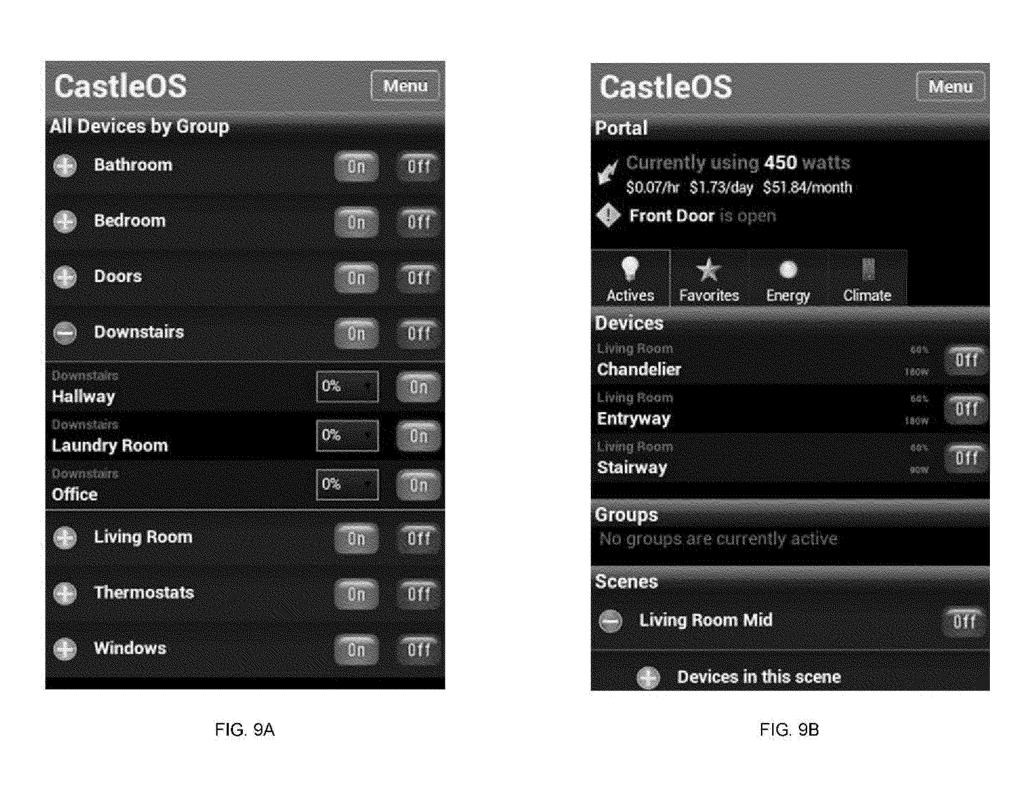

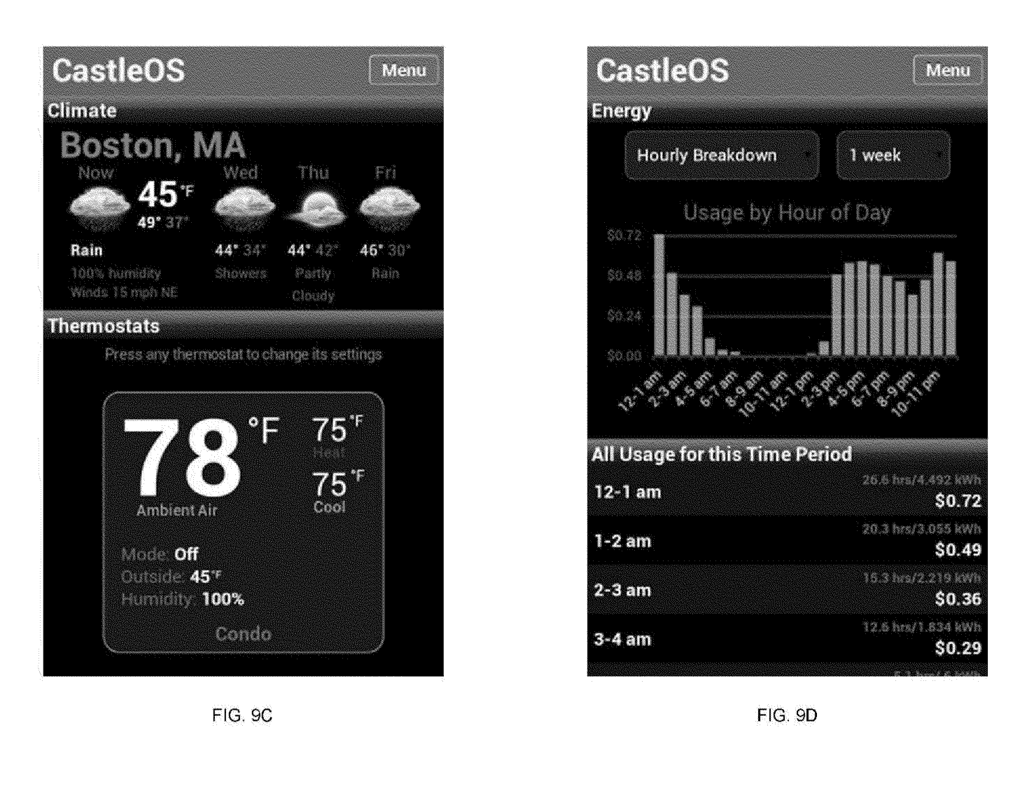

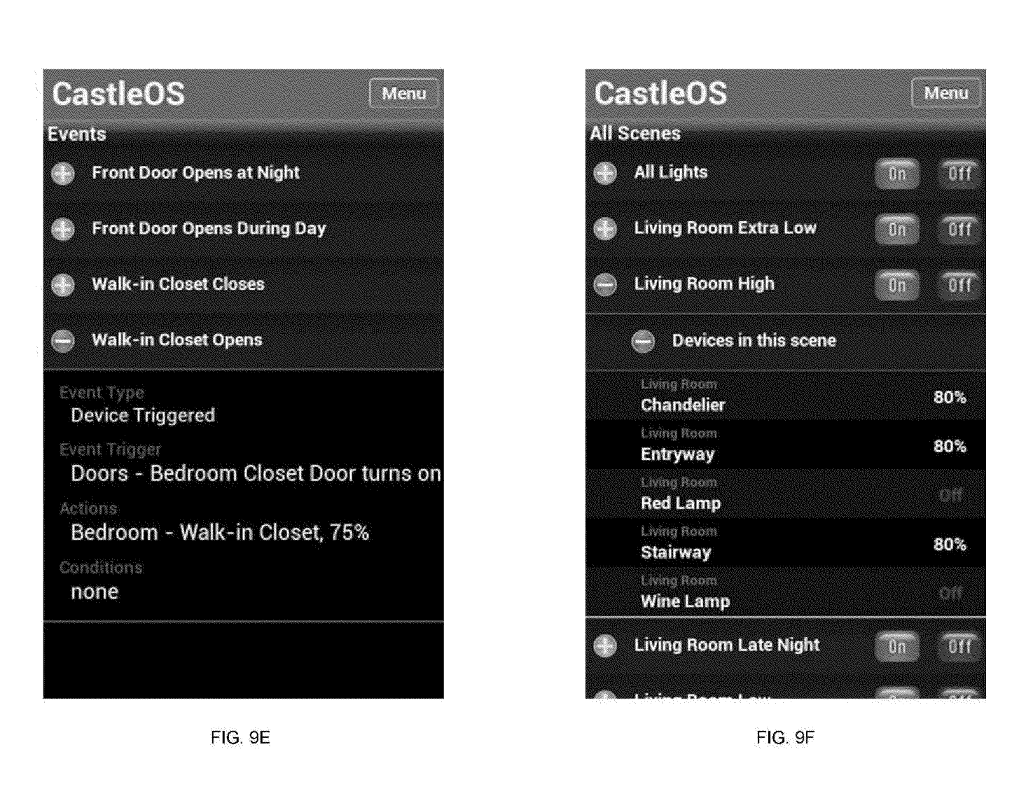

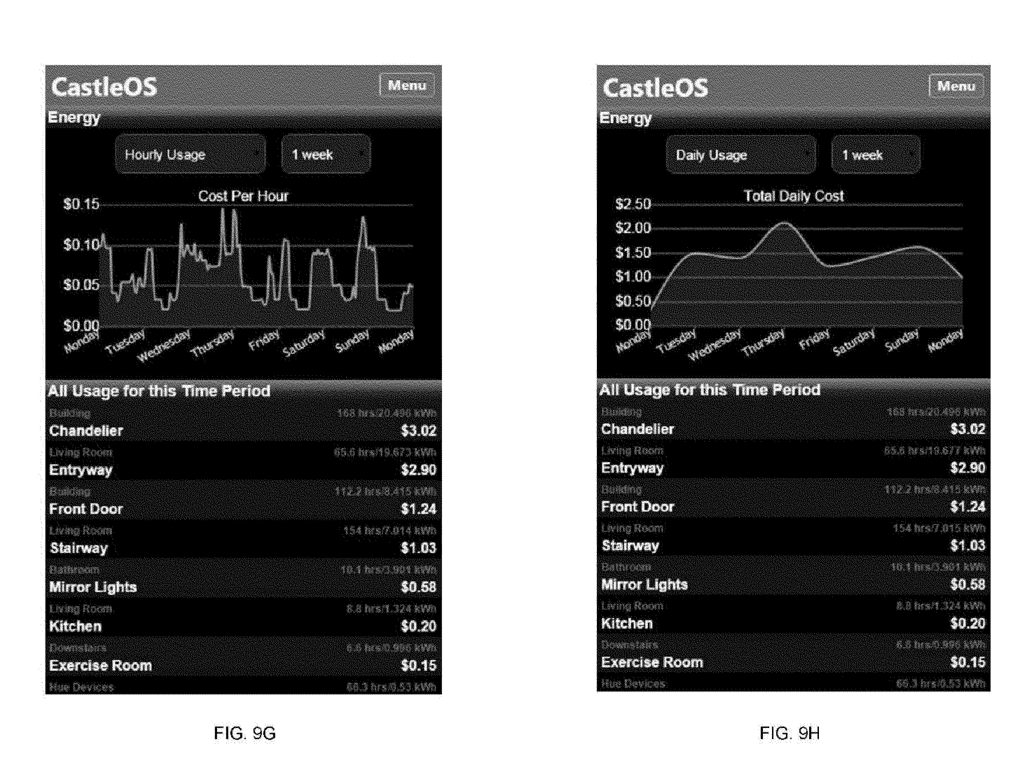

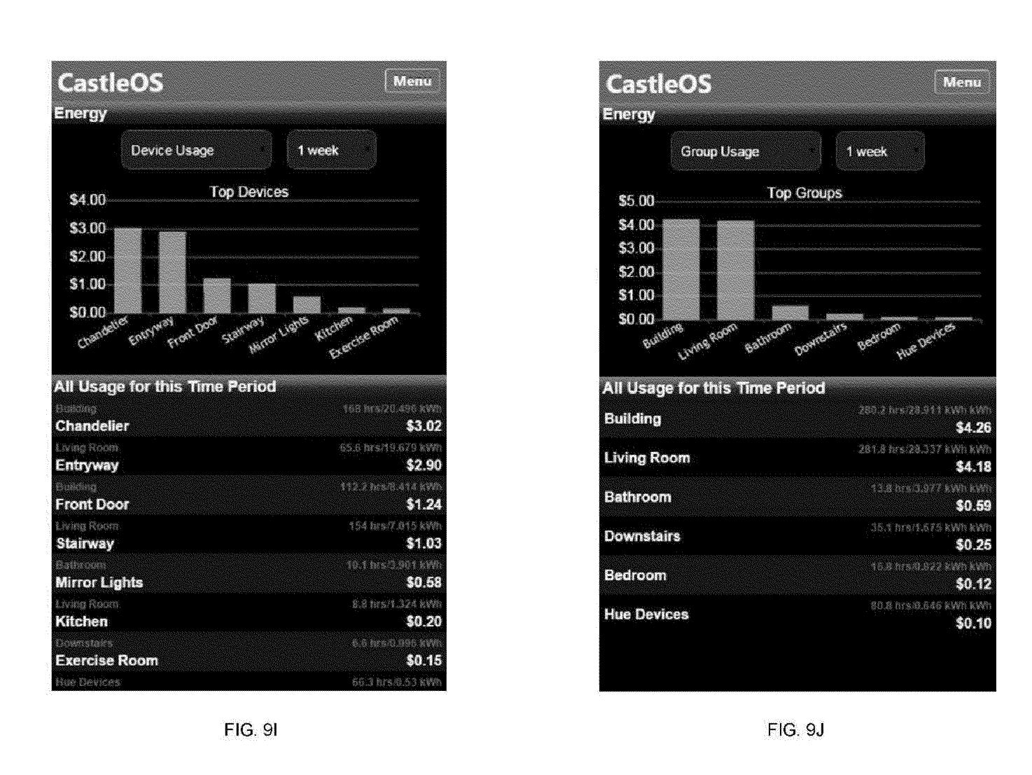

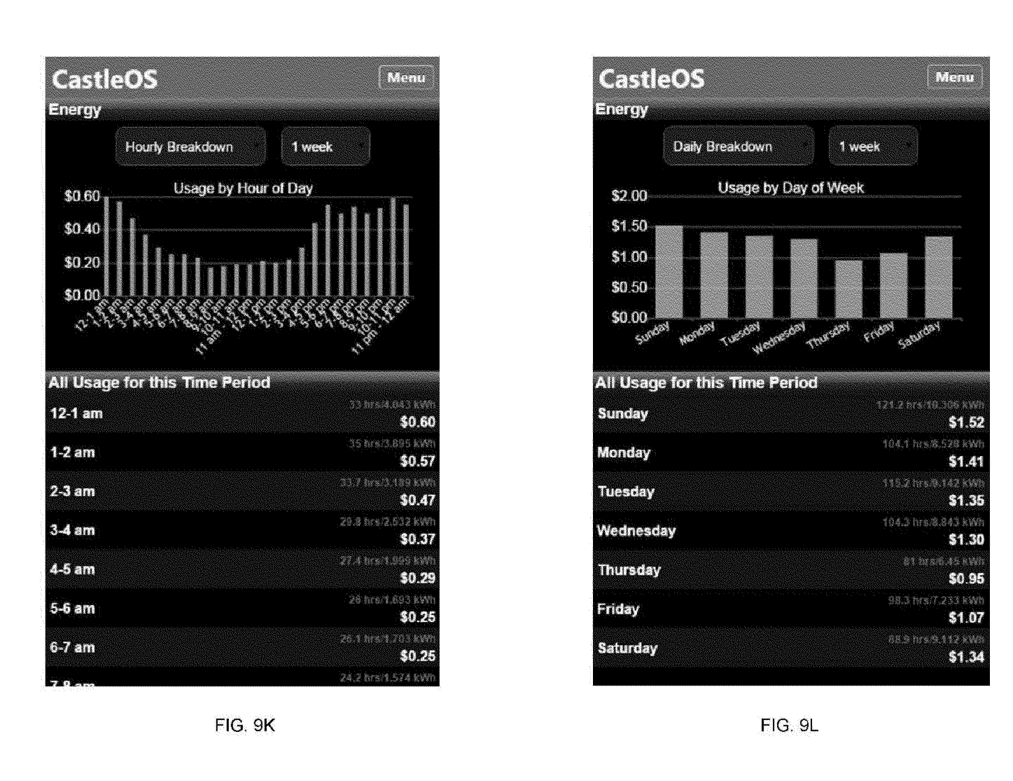

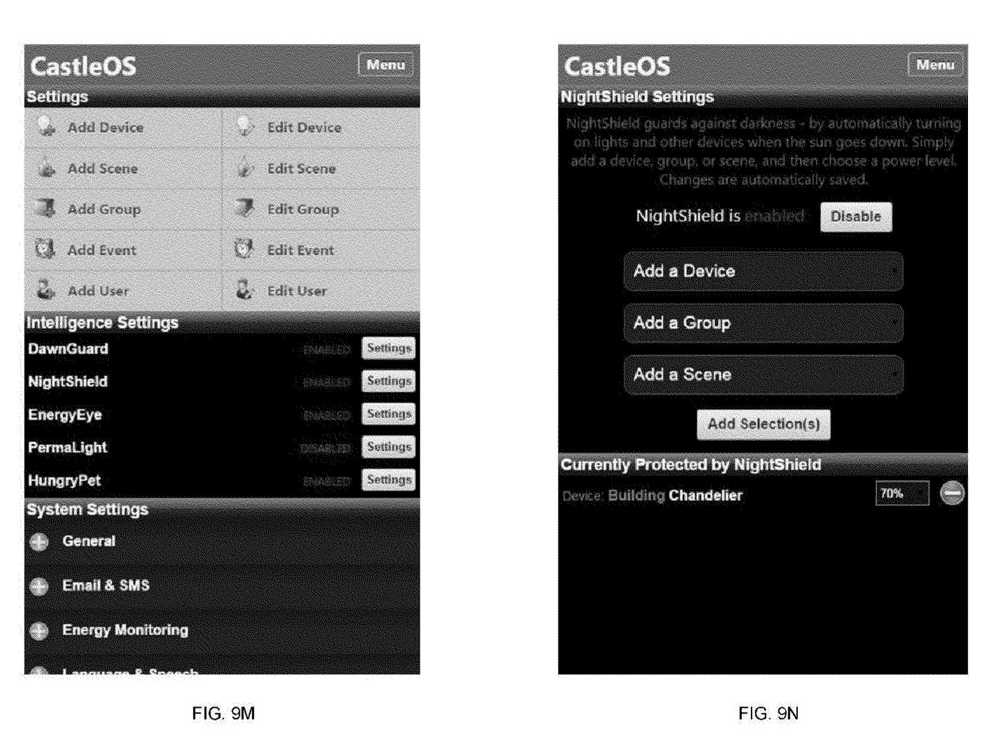

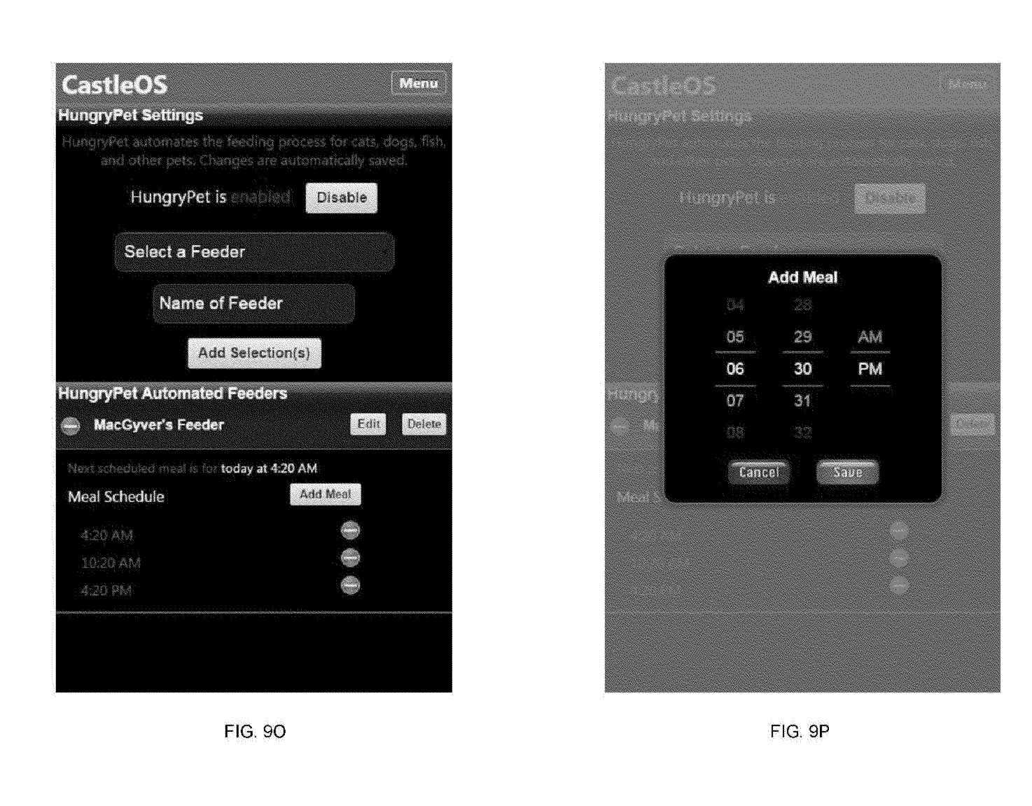

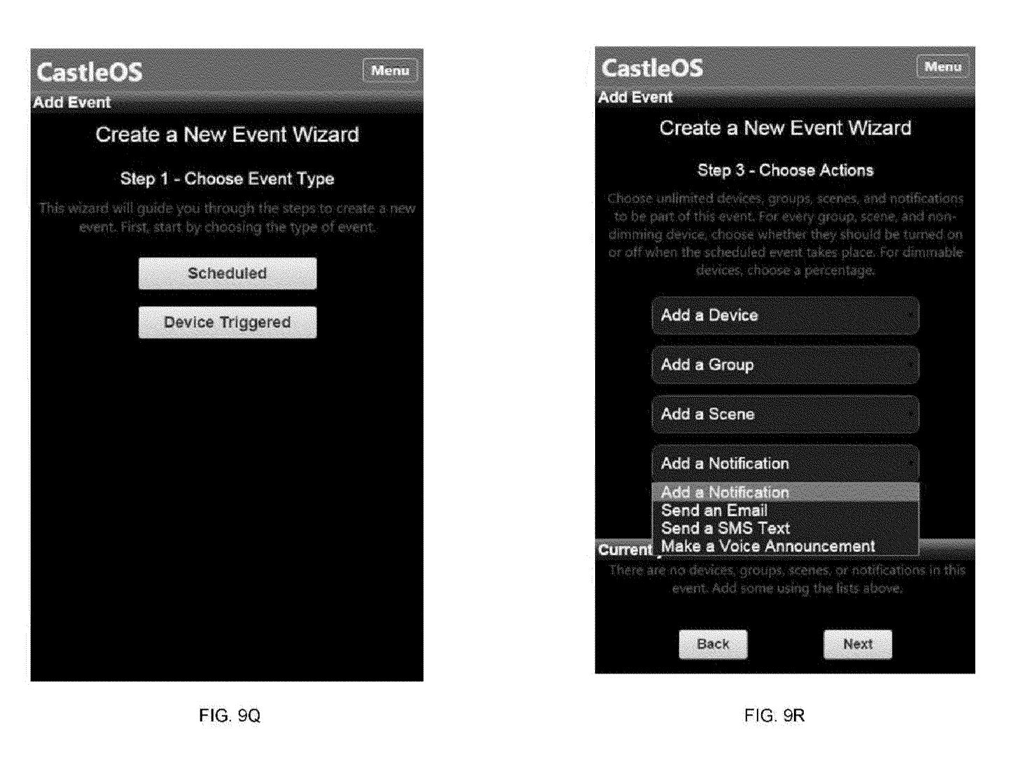

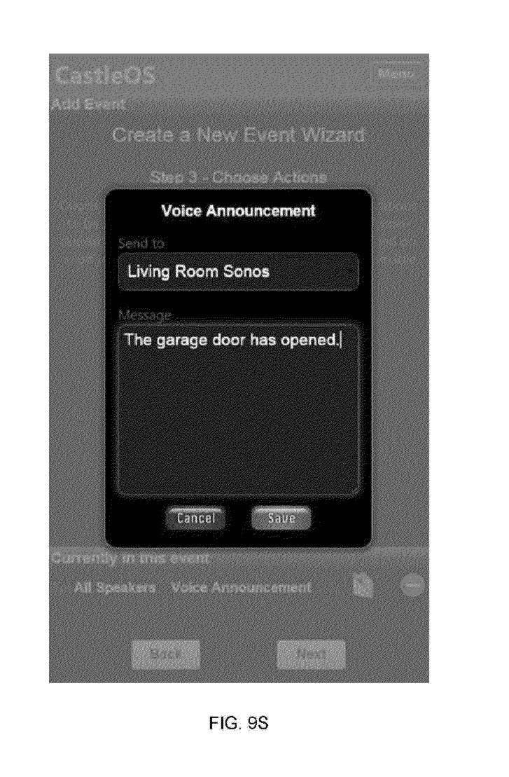

Referring now to FIG. 8, another aspect of the invention provides a method of reporting an emergency. The method includes: detecting that a user announced an emergency; parsing the user's speech to identify additional information about the emergency; and reporting the emergency to an emergency dispatch center along with one or more selected from the group consisting of: additional speech by the user or other humans, a location of the user; information regarding recent door openings; information regarding motion sensor readings, information regarding occupants of one or more rooms, and a photograph of a room.

Other aspects of the invention also allow for automated reporting of an actual or potential emergency to an emergency dispatch center. Advantageously, the invention is capable of providing enhanced information to the emergency dispatch center that a human often cannot provide via a 9-1-1 call. For example, the system can providing information regarding: the user that signaled the potential emergency (e.g., name, age, gender, race, medical conditions, allergies, and the like) and/or the location of the potential emergency (e.g., a particular room or floor). The system can also provide one or more photographs, audio, and/or video of the location of the potential emergency as automatically captured by one or more sensors within the location of the potential emergency. The system can also initiate a telephone call (e.g., over speakerphone) with the emergency dispatch center.

### EQUIVALENTS

Although preferred embodiments of the invention have been described using specific terms, such description is for illustrative purposes only, and it is to be understood that changes and variations may be made without departing from the spirit or scope of the following claims.

### INCORPORATION BY REFERENCE

The entire contents of all patents, published patent applications, and other references cited herein are hereby expressly incorporated herein in their entireties by reference.

1. A method of monitoring status of a hardware device, the method comprising:
obtaining status information for one or more hardware devices; and
communicating with a push notification service to generate a push notification containing the status information for the one or more hardware devices.

2. The method of claim 1, wherein the hardware device is selected from the group consisting of: an electronic switch, a garage door, a thermostat, audio-visual equipment, security systems, a domestic robot, a coffeemaker, an irrigation system, a sump pump, and swimming pool equipment.

3. The method of claim 1, wherein the hardware device supports one or more standards selected from the group consisting of: INSTEON®, UPB®, X10®, Z-WAVE®, and ZIGBEE®.

4. The method of claim 1, further comprising:
receiving the push notification on a computing device; and
updating a widget depicted on a homepage of the computing device to reflect the status information.

5. The method of claim 4, wherein the computing device is selected from the group consisting of: a smartphone, a tablet, and a general purpose computer.

6. The method of claim 4, further comprising:
detecting a user manipulation of the widget; and
in response to the user manipulation of the widget, generating and transmitting one or more instructions for control of the one or more hardware devices.

7. (canceled)

8. A non-transitory computer readable medium containing program instructions executable by a processor, the computer readable medium comprising program instructions that implement of the method of claim 1.

9. A controller adapted and configured to perform the method of claim 1.

10. A method of detecting a potential emergency within a structure, the method comprising:
detecting a pre-defined pattern of actuations of a hardware device; and
upon detecting the pre-defined pattern of actuations of the hardware device, reporting a potential emergency to an emergency dispatch center.

11. The method of claim 10, wherein the hardware device is an electronic switch.

12. The method of claim 10, wherein the hardware device supports one or more standards selected from the group consisting of: INSTEON®, UPB®, X10®, Z-WAVE®, and ZIGBEE®.

13. The method of claim 10, wherein the pre-defined pattern is user-defined.

14. The method of claim 10, wherein the pattern is a sequence of three “ON” actuations, followed by three “OFF” actuations, followed by three “ON” actuations.

15. The method of claim 10, wherein the pattern is a sequence of gestures.

16. The method of claim 15, wherein the sequence of gestures is gesturing a “9”, followed by gesturing a “1”, followed by gesturing a “1”.

17. The method of claim 15, wherein the sequence of gestures is gesturing an “H”, followed by gesturing an “E”, followed by gesturing an “L”, followed by gesturing a “P”.

18. The method of claim 10, wherein the step of reporting the potential emergency to the emergency dispatch center includes one or more selected from the group consisting of: providing information regarding the user that signaled the potential emergency, providing information regarding the location of the potential emergency, providing one or more photograph of the location of the potential emergency, providing audio of the location of the potential emergency, providing video of the location of the potential emergency, and initiating a telephone call between the person that signaled the potential emergency and the emergency dispatch center.

19. A non-transitory computer readable medium containing program instructions executable by a processor, the computer readable medium comprising program instructions that implement of the method of claim 10.

20. A controller adapted and configured to perform the method of claim 10.

21. A method of detecting a particular person within a room, the method comprising:
utilizing a skeletal detection algorithm to identify one or more humans;
capturing one or more images including one or more faces of the one or more humans; and
using a facial recognition algorithm to identify the one or more humans.

22. The method of claim 21, further comprising:
detecting whether the one or more humans are authorize to be in the room; and
if the one or more humans are not authorized to be in the room, generating an alarm.

23. A non-transitory computer readable medium containing program instructions executable by a processor, the computer readable medium comprising program instructions that implement of the method of claim 21.

24. A controller adapted and configured to perform the method of claim 21.

25. A method of detecting an anomalous event, the method comprising:
monitoring behavior of an individual using one or more sensors;
logging the behavior;
deriving a plurality of patterns from the behavior;
monitoring additional behavior; and
comparing the additional behavior to plurality of patterns derived from the behavior.

26. The method of claim 25, further comprising:
if the additional behavior does not match one of the plurality of patterns, comparing the additional behavior to one or more pre-defined anolomalous patterns; and
if one or more anomalous patterns are detected, contacting n emergency dispatch center.

27. A controller adapted and configured to perform the method of claim 25.

28. A non-transitory computer readable medium containing program instructions executable by a processor, the computer readable medium comprising program instructions that implement of the method of claim 25.

29. A method of reporting an emergency, the method comprising:
detecting that a user announced an emergency;
parsing the user's speech to identify additional information about the emergency; and
reporting the emergency to an emergency dispatch center along with one or more selected from the group consisting of: additional speech by the user or other humans, a location of the user; information regarding recent door openings; information regarding motion sensor readings, information regarding occupants of one or more rooms, and a photograph of a room.

30. The method of claim 29, further comprising:
acknowledging receipt of the emergency by taking one or more actions selected from the group consisting of: playing one or more sounds and flashing lights within the room.

31. The method of claim 29, wherein the location of the user specifies a particular room within a structure.

32. A controller adapted and configured to perform the method of claim 29.

33. A non-transitory computer readable medium containing program instructions executable by a processor, the computer readable medium comprising program instructions that implement of the method of claim 29.
